(19) United States
(12) Patent Application Publication
(10) Pub. No.: US 2012/0054123 A1
(43) Pub. Date: Mar. 1, 2012

(54) HOT WATER HEATER WITH AN INTEGRATED FLOW METER

(75) Inventors: Jay Andrew Broniak, Louisville, KY (US); Michael Thomas Beyerle, Pewee Valley, KY (US); Joseph Mark Brian, Louisville, KY (US); David C. Bingham, Louisville, KY (US)

(73) Assignee: General Electric Company

(21) Appl. No.: 12/873,768

(22) Filed: Sep. 1, 2010

(51) Int. Cl. G06F 19/00; F16K 37/00; G01F 1/00

(52) U.S. Cl. 705/412; 702/45; 137/551

(57) ABSTRACT

An apparatus and method are disclosed that monitors water of a water heating and storage system. At least one flow meter is integrated within the system having a tank for storing water to be heated. The meter is in communication with other devices in a home network and a controller of the network with a communication module. The flow meter is connected to the cold water inlet pipe and/or the hot water outlet pipe of the system. Data is presented to the user to enable more informed use of water and of water consumption habits.

### BACKGROUND

The present disclosure relates generally to hot water heater systems and methods for operating the same. More particularly, it relates to systems and methods for monitoring water flow of water heater systems.

Water heater storage tanks are used for storing and supplying hot water to households. A typical residential water heater holds about fifty gallons (190 liters) of water inside a steel reservoir tank. A thermostat is used to control the temperature of the water inside the tank. Many water heaters permit a consumer to set the thermostat to a temperature between 90 and 150 degrees Fahrenheit (F) (32 to 65 degrees Celsius (C)). To prevent scalding and to save energy, most consumers set the thermostat to heat the reservoir water to a temperature in a range between 120.0 degrees F. to 140.0 degrees F. (about forty-nine degrees C. to sixty degrees C.).

A water heater typically delivers hot water according to the thermostat temperature setting. As a consumer draws water from the water heater, the water temperature in the water heater usually drops. Any time the thermostat senses that the temperature of the water inside the tank drops too far below thermostat's set point, power is sent to the electric resistance heating element (or a burner in a gas water heater). The electric elements then draw energy to heat the water inside the tank to a preset temperature level.

In some locations of the United States and globally, the cost for electrical energy to heat water in a tank can vary as a function of the time of day, day of the week and season of the year. In areas of the United States where energy is at a premium, utility companies often divide their time of use rates into off-peak and on-peak energy demand periods with a significant rate difference between the periods. For example, energy used during off-peak hours may cost the consumer in United States dollars around 5 cents to 6 cents per kilowatt hour (kWh), while on-peak period energy may cost anywhere from 20 cents per kWh to $1.20 or more per kWh.

A water heater that heats based on the water demand of a typical household is likely to heat at the same time as when energy demand on a utility company is at its highest. As a result, drawing energy to heat a water heater during these on-peak energy periods increases a consumer's monthly energy bill especially if the consumer is not aware of the amount of water being consumed daily.

Thus, there is a need to better inform consumers of the amount of water being consumed for improving cost, efficiency and conservation. In addition, a system is needed that can reduce cost and consumer demand from the hot water heater when energy rates are high and use energy when electric rates are low.

### SUMMARY

The present disclosure provides a water heating and storage system and a method for monitoring water consumption in a water heating and storage system within a home network. A water flow measuring device is used to measure water amounts being consumed at a home. A controller, such as a home energy manager, for example, is communicatively linked to the water flow measuring device of the system, which includes a memory for storing data and executable instructions for the method. Data is received from the water flow measuring device that includes an amount of water consumed from a cold water inlet pipe over a predetermined period of time. The data is communicated from a communication module to the controller for processing and presented to the user or homeowner via a user display. The data is used to determine the amount of water being consumed, which is compared to earlier data from a different period of time. In addition, the amount of water from a hot water outlet pipe is also measured and presented to the user via the display. Other information may also be presented to the user including, but not limited to the following: temperature of the hot water in the tank, energy and cost of heating the water in the tank.

In one embodiment, a water heating and storage system has an insulated tank for storing water and a flow meter integrated with the system that is used to measure an amount of water over a period of time. The tank has a communication module that communicates the data provided from the flow meter to a central controller of a home network and also to other devices of the network, for example. The flow meter is connected to a hot water outlet pipe and/or to a cold water inlet so that a total amount of hot water, a total amount of cold water, a total water consumption, and a cost for heating is determined at the central controller for presenting to a homeowner/user.

### BRIEF DESCRIPTION OF THE DRAWINGS

FIG. 1 is an isometric view of a water heater system in accordance with an illustrative embodiment of the present disclosure;

FIG. 2 is a graph illustrating time relationship to hot water usage; and

FIG. 3 illustrates a flow diagram for monitoring a water heating and storage system.

### DETAILED DESCRIPTION

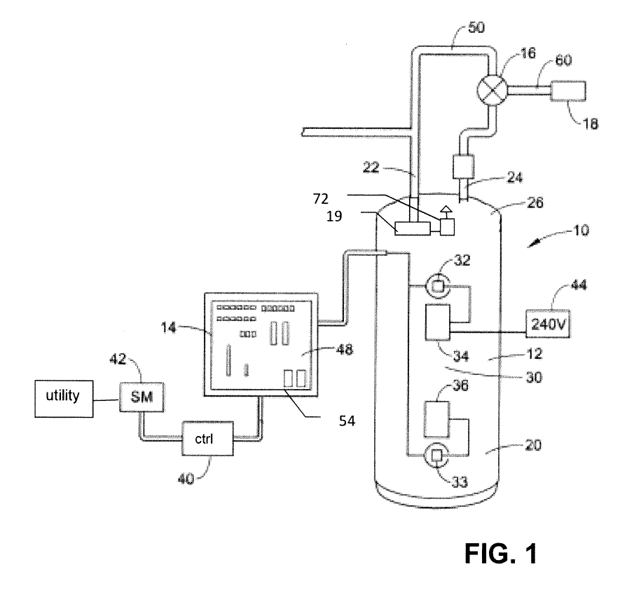

Referring now to FIG. 1, a water heating and storage system 10 in accordance with an exemplary embodiment of the present disclosure is illustrated. The water heating and storage system 10 is a water heater that includes an operation control device/panel 14, a cutoff valve 18 and a water meter 19 used for measuring a water flow amount. The water heating and storage system 10 comprises an electric water heating and storage system, however, it could be a gas water heating and storage system, or a hybrid water heating and storage system.

The water heating and storage system 10 includes a shell 20, a “cold in” pipe 22, a “hot out” pipe 24, and a cover 26. The casing surrounds a tank 30 that acts as an interior reservoir for water, which is heated by an electric resistance heater arrangement, but which could be heated by a gas burner, or it could be a hybrid system for heating water via more than one source of power, for example. Insulation is provided around the exterior of the tank to reduce heat transfer. For typical domestic household use, the tank is about 80-gallon capacity or more. The cold in pipe delivers water to the water heating and storage system at a temperature less than about 120 degrees F. (about 49 degrees C.), typically 40 to 80 degrees F. (4 to 27 degrees C.). The hot out pipe conventionally delivers water away from the water heating and storage system at a temperature of about 120 degrees F. (about 49 degrees C.). The cover and base seals the shell providing an enclosure for the tank, insulation and wiring system.

The water heating and storage system 10 further includes a pair of upper and lower heating elements 32, 33 and a pair of upper and lower thermostats 34, 36, for example. The present disclosure is not limited to any specific number of heating elements or thermostats illustrated herein and the water heating and storage system 10, for example, may have less or more heating elements and/or thermostats without departing from the disclosure. The heating elements 32, 33 are electric resistance heating elements. Heating element 32 is an upper heating element, and heating element 33 is a lower heating element. The thermostats 34, 36 may be thermomechanical devices that mechanically respond to temperature changes to either make or break the energy circuit controlling the heating element. In a microprocessor controlled heater, the thermostats may use other technology, such as thermistors instead of a mechanical device to determine temperature. The thermostat devices 34, 36 each include thermal limiting devices to regulate and limit the water temperature in conventional fashion. The thermostatically controlled heating elements may be configured to be energized simultaneously or sequentially.

When the water heating and storage system 10 is supplied power directly, the thermostats provide sole control over the flow of energy to the heating elements to maintain a predetermined temperature in the tank. If the thermostats 34, 36 provide the only control over the flow of energy to the water heating and storage system, then the water heating and storage system may operate during on-peak energy periods. To provide more control over the operation of the heating elements, the water heating and storage system includes the demand response control panel which is configured to disable or prevent energizing of the heating elements in response to demand response signals from the energy providing utility conveying information regarding the state of the utility, such as rate or energy usage condition information. In addition, a manual override function (not shown) is present for a user or homeowner to override any demand response signal.

The cutoff valve 18 is provided as a safety backup. In other words, the cutoff valve is a thermostat-controlled safety device that automatically closes if the water in the service pipe 60 reaches a predetermined high temperature, such as about 160.0 degrees F. (about seventy-one degrees C.).

In one embodiment, the controller 40 communicates with a communication module 72 that is connected to a flow meter 19. Total water flow measurement amounts are monitored through the cold water inlet pipe 22 with the flow meter 19 operatively connected to the communication module 72. The communication module may be a wireless module or a wired module that communicates with an analog or digital signal to other devices within the home network and/or the controller. For example, the water flow meter 19 is integrated into the system 10 at assembly and connects to the incoming water line 22, as illustrated, but can also be located at the hot water out pipeline 24 to be used for measuring a total hot water flow and communicating data for the measurements (e.g., a number of pulses) with the communication module 72. In another embodiment, a flow meter may be located at either the cold water inlet or hot water outlet of the water heating and storage system 10. In addition, the present disclosure is not limited to any number of water flow meters, and FIG. 1 is meant as an illustrated example. Further, the flow meter 19 together with the communication module 72 measures the flow rate or the volume of water flowing into the tank and provides an output signal representative thereof, which is sent to the central controller 40 and/or the operation control device panel 14 for determining a total flow amount for all water drawn into the tank for storage, the hot water only and/or cold water together with other data, which may be displayed in a display.

There are several ways to accomplish communication of data from the flow meters, including but not limited to power line carrier (PLC) (also known as power line communication), FM, AM SSB, WiFi, ZigBee, Radio Broadcast Data System, 802.11, 802.15.4, etc. The controller and other devices within the home network (e.g., HVAC unit, programmable thermostat, user display device, etc.) may communicate in analog or digital format with the system 10 directly therefore via a wired, optical and/or wireless connection, and the present disclosure is not limited to any one specific method for communicating data.

The operation control device/panel 14 includes a demand response (DR) control 48 connected to a transceiver 54, which is connected to a central controller 40, such as a home energy manager, for example, and to a “smart” meter 42. A power connection 44 is provided to the water heating and storage system. The upper and lower heating elements as well as the control panel is provided power from this connection. The control panel serves to interrupt power to the heating elements based on a communication signal to an interfaced port and can process demand response signals at the control 48 in at least one of a plurality of operating modes having at least an enabling mode and a disabling mode for powering the heating elements.

The demand response control 48 operates as a user operable input device that communicates via a signal line with the controller 40 within a home or directly from an energy provider signal, via a transceiver or hard line connection. The signal line communicates status information such as the response level regarding off-peak and on-peak information from energy generating facilities. The demand response control can be configured to receive and process a signal indicative of a current state of a utility or energy provider including at least one of the following energy rate conditions: normal or low rate operation, medium rate operation, high rate operation and critical rate operation. The utility state has an energy cost. The demand response control is configured to override the operating mode of the water heating and storage system based on a user selected targeted energy cost. If a current energy cost exceeds the user selected cost, a water heating and storage system is operated in an energy saving mode. If current energy cost is less than the user selected cost, the operation control device operates the water heating and storage system in a normal operating mode. When the controller is configured in the system, the controller communicates a command signal to the individual appliances, including the water heating and storage system according to default or user established parameters, minimizing energy utilization while maintaining functionality.

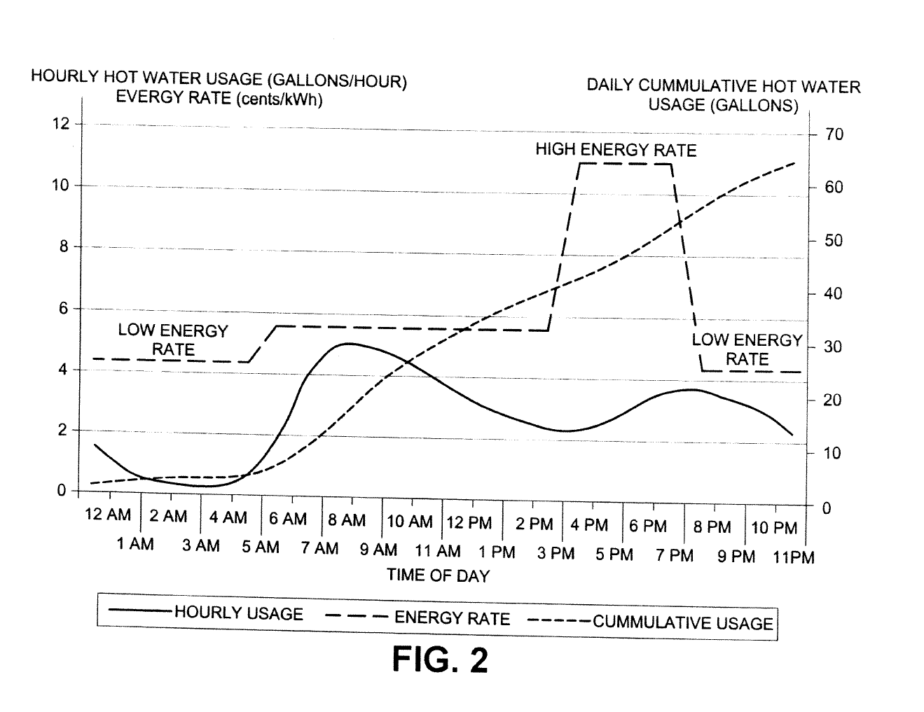

FIG. 2 shows a graph illustrating the clock time relationship of typical hot water usage and the time of use energy rate. The graph is one example of a graph generated for informing the user of water consumption information in relation to power consumption. While the water usage of a hot water heater is monitored the different price schedules are also illustrated so that a user is able to monitor water usage in conjunction with times of day and the energy rate of a utility provider, for example. Homeowners and the occupants can track their past behavior daily at times, amounts and cost levels needed to change their future behavior to save cost and conserve water.

For example, the controller 40 comprises memory therein that can also collect water consumption data for the home. A table may be generated for the water heating and storage system 10 that includes historical home data and data that is currently updated, which may be used in a client application running on a device, such as a computer or mobile phone, for presenting graphs or other forms of the water consumption data to the user.

Through the control device panel 14, a consumer inputs the preferred response to the tiered signal levels from the energy provider and/or the programmed daily off-peak/on-peak demand periods scheduled into the timer. The signal line also delivers this information into the control panel from utility companies. The control device panel 14 may also display the water flow measurements determined.

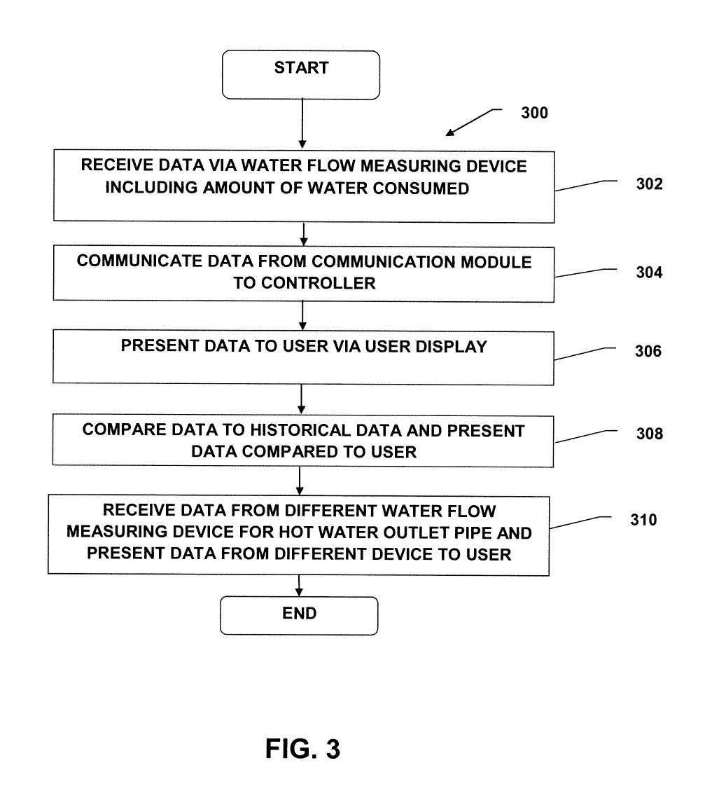

Example methodology 300 for monitoring water flow of a water heating and storage system within a home network is illustrated in FIG. 3. While the method is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 300 of FIG. 3 is for monitoring the water flow of cold water and/or hot water into a home through a water heating and storage system. The method is provided for a home network that includes at least one water meter that is integrated in the system with a water storage tank for measuring hot water being consumed at a home. A central controller is communicatively linked to the water meter and includes a memory storing executable instructions for the method.

The method begins at start and at 302 where communication data is received via a water flow measuring device that is operatively coupled to a cold water pipeline for measuring cold water flow therein. The data is communicated to the central controller, which can include an amount of water passing through or being consumed via the cold water inlet pipe. The controller can determine amounts of water being consumed over a predetermined period of time, such as daily and/or hourly periods. The water meter is a flow meter that is inserted in the water line or some other measuring device integrated into the system and connected to the cold water pipe that is capable of being used to measure water amounts or water flow amounts in a pipeline. The flow meter at the cold water inlet pipe, for example, has a communication module that wirelessly or in a wired fashion transmits communication data to the controller at 304.

At 306 the data collected by the flow meter is received in a memory from where the data is presented to a user or homeowner via a user display or panel. A water flow rate, an average water amount, a total water amount, for example, can be calculated or received by the central controller with the flow meter and communication module (e.g., a wireless or wired transceiver). The period of time may vary and could be about sixty minutes or less, for example. Other increments of time are also possible as one of ordinary skill in the art will appreciate. One of ordinary skill the art will appreciate operation of a flow meter, the details of which are not fully discussed herein. For example, a water meter can report incremental water consumption by sending a communication signal for each gallon/liter consumed. The central controller can then take the difference between each reading and calculate the flow rate.

At 308 data is received from a different water flow measuring device and communication module that includes an amount of water consumed from a hot water outlet pipe and an amount over a predetermined period of time is determined by the central controller for hot water consumption. For example, a flow meter is integrated with the system and connected at the hot water outlet pipe for measuring the amount of hot water flowing, which is communicated to the central controller. The data received is presented to the user via a user display or panel, for example. For example, a temperature of hot water remaining in a tank of the system, and cost of heating the water in the tank, and/or a total amount of water consumption from the tank can be presented to the user via the user display or panel. At 310 the data stored is compared in a chart or any other form of data compiling that includes a comparison of the amount of water consumed over a period of time to earlier historical data stored in the memory, which includes an amount of water consumed over a different period of time, such as by a different day or different time duration.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A water heating and storage system, comprising
an insulated tank for containing water to be heated;
the tank having a cold water inlet pipe for water to flow therein;
a flow meter that is used for measuring an amount of water drawn from the tank; and
a communication module operatively connected to the flow meter for communicating aggregate water consumption data from the water flow meter to a central controller of a home network.

2. The water heating and storage system of claim 1, wherein the flow meter is connected to the cold water inlet pipe for measuring water flow therethrough.

3. The water heating and storage system of claim 1, wherein the flow meter is connected to a hot water outlet pipe for measuring hot water flow therethrough.

4. The heating and storage system of claim 1, wherein the flow meter includes an analog or digital output signal that is connected to the communication module for transmission of water consumption data.

5. The water heating and storage system of claim 1, comprising:
an operation control device configured to receive and process a demand response signal and operate the tank in at least one of a plurality of operating modes, including at least an enabling mode and a disabling mode.

6. The water heating and storage system of claim 5, wherein the operation control device comprises a demand response control which is communicatively connected with a home energy manager device in communication with an energy provider.

7. The water heating and storage system of claim 5, wherein the operating control device is configured to be responsive to demand response signals including at least one of the following energy rate conditions: normal or low rate operation, medium rate operation, high rate operation and critical rate operation.

8. The water heating and storage system of claim 5, wherein the operating control device further comprises a user operable input device and the control device is responsive to the input device to selectively respond to a signal indicative of a current state of an associated utility, wherein a manual override is provided for a user to override a demand response signal.

9. The water heating control and storage system of claim 5, wherein the current state has an associated energy cost and wherein the operation control device is configured to override the operating mode of the water heater based on a user selected targeted energy cost,
wherein if current energy cost exceeds the user selected cost, the operation control device operates the water heater in the energy savings mode, and
wherein if the current energy cost is less than the user selected cost, the operation control device operates the water heater in the normal operating mode.

10. The water heating and storage system of claim 1, wherein the insulated tank comprises at least one of a gas heated insulated tank for heating water via a gas source, an electric heated insulated tank, and a hybrid electric/heat pump heated insulated tank for heating water via more than one source of power.

11. The water heating and storage system of claim 1, wherein the communication module is operatively coupled to the central controller to transmit water consumption data to the central controller and to other different devices within the home network.

12. A water heating and storage system, comprising
an insulated tank having a cold water inlet pipe for water to flow therein to be stored and heated;
a flow meter used to measure the amount of water drawn from the tank;
a communication module for communicating the data from the water flow meter to a user display; and
a processor coupled to the flow meter for aggregating and processing water usage data received therefrom.

13. The water heating and storage system of claim 12, wherein the flow meter is operatively connected to a hot water outlet pipe that is used to measure a total amount of hot water consumed over a period of time.

14. The water heating and storage system of claim 12, wherein the flow meter includes an analog or digital output signal connected to the communication module for transmission of water consumption data, wherein the communication module is operatively coupled to the central controller to transmit water consumption data to the central controller and to other different devices within the home network.

15. The water heating and storage system of claim 12, wherein a user display presents the data having the total amount of water consumed over the predetermined period of time, a total amount of cold water and/or a total amount of hot water consumed over the predetermined period of time.

16. The water heating and storage system of claim 12, wherein the user display presents the temperature of the hot water remaining in the tank, energy and cost of heating the water in the tank.

17. A method for monitoring water consumption in a water heating and storage system within a home network having a hot water storage tank and a water flow measuring device used for measuring water usage, and a controller communicatively linked to the water flow measuring device of the water heating and storage system, the controller including at least one memory for storing data and executable instructions, comprising:
receiving water usage data via the water flow measuring device indicative of the amount of water drawn from the;
communicating the data from a communication module to the controller for processing the data; and
presenting the water usage data to a user via a user display.

18. The method of claim 17, further comprising:
comparing the measured water usage data to historical water usage data stored in the memo; and
presenting the resulting comparative data to the user via the user display.

19. The method of claim 17, further comprising:
sending the data to a central controller of the home network; and
presenting to the user via the user display a at least one of the temperature of hot water remaining in the storage tank, a recovery time for how long the tank will take to heat the water therein up to a setpoint, energy and cost spent on heating the water in the tank, and/or a total amount of water drawn from the tank,
wherein the central controller comprises an energy manager device that receives demand response signals from an energy provider and sends command instruction to an operation control device of the water heating and storage system.
